(19) United States
(12) Patent Application Publication
(10) Pub. No.: US 2026/0336625 A1
(43) Pub. Date: Oct. 29, 2026

(54) Method for the Safety Assessment of a Lane Change Maneuver in Automatic Driving Operation of a Vehicle

(71) Applicant: MERCEDES-BENZ GROUP AG, Stuttgart (DE)

(72) Inventors: Laurin VASILE, Stuttgart (DE); Maximilian SEEMANN, Duelmen (DE)

(21) Appl. No.: 19/103,935

(22) PCT Filed: Jul. 18, 2023
(86) PCT No.: PCT/EP2023/069958

§ 371 Date: Feb. 14, 2025

(30) Foreign Application Priority Data
Aug. 16, 2022 (DE) 10 2022 002 969.3

(51) Int. Cl. B60W 30/18; B60W 30/09; B60W 30/095; B60W 60/00

(52) U.S. Cl. CPC B60W 30/18163; B60W 30/09; B60W 30/0953; B60W 30/0956; B60W 60/0015; B60W 2554/802; B60W 2554/804

(57) ABSTRACT

A method for safety assessment of a lane change maneuver in an automatic driving operation of a vehicle. Before initiating a lane change maneuver from a left or a right lane to a middle lane, determining a collision risk by hypothetical lane change maneuvers of other vehicles. Longitudinal accelerations of the other vehicles are determined on a basis of a maximum lane change duration and a merging moment which lead to a collision due to an overlap of vehicle surfaces of the vehicles. An execution of the lane change maneuver is assessed depending on a relative longitudinal position of the vehicle relative to the other vehicles and initial relative longitudinal speeds of the vehicle to the other vehicles at a start of a lane change maneuver using a collision probability as a safety measure and a minimum distance when a collision does not occur as a further safety measure.

### BACKGROUND AND SUMMARY OF THE INVENTION

The invention relates to a method for the safety assessment of a lane change maneuver in automatic driving operation of a vehicle having a surroundings sensor system, wherein surroundings of the vehicle and objects found in these surroundings are detected by means of signals captured by the surroundings sensor system.

A method for assessing a risk connected with a driving operation of an automatic vehicle control system is known from U.S. Pat. No. 8,244,408 B2. A vehicle is configured to execute an automatic lane change maneuver, and is equipped with a monitoring system. Each of multiple objects in the vicinity of the vehicle is monitored. Locations of each of the objects are predicted relative to a projected trajectory of the vehicle and a collision risk level between the vehicle and each of the objects is assessed.

The object of the invention is to specify a novel method for the safety assessment of a lane change maneuver in automatic driving operation of a vehicle.

A method for the safety assessment of a lane change maneuver in automatic driving operation of a vehicle having a surroundings sensor system, wherein surroundings of the vehicle and objects found in these surroundings are detected by means of signals captured by the surroundings sensor system, provides in accordance with the invention that:
before an initiated lane maneuver of the vehicle from a left lane to a middle lane or from a right lane to a middle lane of a multi-lane carriageway section, a collision risk is determined by means of hypothetical lane change maneuvers of further vehicles on the right lane or the left lane, wherein
longitudinal accelerations are calculated on the basis of a maximum lane change duration and a merging moment, which lead to a collision due to an overlap of vehicle surfaces of the vehicle and the other vehicles,
an execution of the lane change maneuver is assessed depending on a relative longitudinal position of the vehicle in relation to the other vehicles and relative longitudinal speeds of the vehicle in relation to the other vehicles at the start of a lane change maneuver using a collision probability as a safety measure and a minimum distance if a collision does not occur as a further safety measure.

In particular, the method provides that it is possible to check whether a lane change can still be carried out safely before the vehicle starts to change lanes, even if the vehicle misjudges the lane change maneuvers in relation to the other vehicles or a lane change cannot be predicted from a context. For this reason, the collision probability is only determined on the basis of the longitudinal acceleration, as it is not possible to predict whether other vehicles will change lanes.

By applying the method, a collision risk of a vehicle can be assessed/quantified at a tactical level for carrying out a lane change maneuver into the middle lane.

A vehicle system for automated, in particular autonomous driving, can reduce the risk of collision even before the lane change maneuver by adjusting its target behaviour or postpone the start of the lane change maneuver if both a positive and a negative acceleration effort is too high for the vehicle and/or until an initial situation for a safe lane change has improved.

Exemplary embodiments of the invention are explained in more detail below using the drawings.

### BRIEF DESCRIPTION OF THE DRAWINGS

FIG. 1 schematically shows a carriageway section having three lanes and two vehicles;

FIG. 2 schematically shows two depictions of the carriageway section with one and the same initial situation and changed longitudinal acceleration;

FIG. 3 schematically shows a derivation of the merging moment in a particular situation;

FIG. 4 schematically shows a derivation of the merging moment in another particular situation;

FIG. 5 schematically shows a derivation of the merging moment in another particular situation;

FIG. 6 schematically shows a derivation of the merging moment in another particular situation;

FIG. 7 schematically shows a depiction of starting position borderline cases and their relative longitudinal velocity curves;

FIG. 8 schematically shows a derivation of a collision probability as a safety measure;

FIG. 9 schematically shows a depiction of a calculation of a minimum distance between the vehicle and a further vehicle driving in the next but one lane as a further safety measure; and

FIG. 10 schematically shows a depiction of different borderline cases for calculating longitudinal acceleration limits.

### DETAILED DESCRIPTION OF THE DRAWINGS

Parts corresponding to one another are provided with the same reference numerals in all figures.

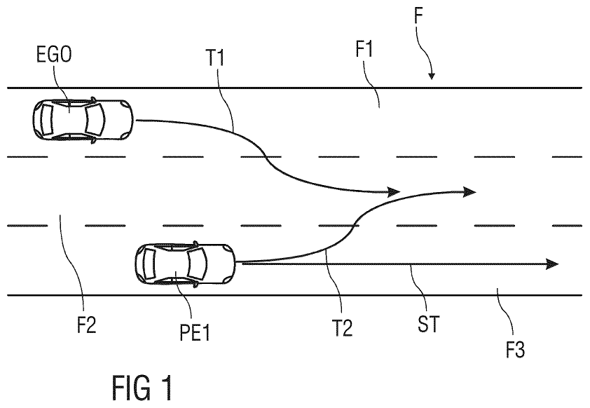

FIG. 1 shows a carriageway section F having three lanes F1 to F3 running in the same direction. A vehicle EGO is driving in automatic driving operation in a left lane F1 and intends to perform a lane change maneuver to a middle lane F2. A lane change trajectory T1 of the vehicle 1 from the left lane F1 to the middle lane F2 is depicted.

Another vehicle PE1 is driving in a right lane F3, which may intend to carry out a lane change maneuver into the middle lane F2, i.e., even without a recognizable intention. A hypothetical lane change trajectory T2 of the other vehicle PE1 from the right lane F3 to the middle lane F2 is also depicted. FIG. 1 also shows a lane following trajectory ST of the other vehicle PE1, which relates exclusively to the right lane F3.

Changing lanes is a comparatively complex driving maneuver for automated, in particular autonomous, driving operation of a vehicle EGO. This requires the longitudinal and lateral movements of the vehicle EGO to be planned and implemented, taking into account the surrounding situation.

According to Donges and Michon, it is known that an assessment of a lane change maneuver takes place on three levels, namely strategic, tactical and operational. The following description of the problem relates in particular to the tactical level, which describes the attractiveness and feasibility of a lane change maneuver. Usually, an autonomous lane change at this level is only analysed with the inclusion of object information, which is assigned to the vehicle's own left lane F1 and a target lane ZS, i.e., the middle lane F2, according to the present exemplary embodiment in FIG. 1. However, object information from other vehicles PE1 to PE3, which are shown in the following figures, in a next but one lane, i.e., the right lane F3, is not taken into account or only indirectly, for example via potential fields, if a predicted behaviour has no relevance for the target lane ZS. The number of additional vehicles PE1 to PE3 is not fixed at 3 and can vary. Incorrect predictions or lane changes that are not apparent from a context are therefore not taken into account or are only taken into account by generic fallback trajectories. However, during lane change maneuvers on three- or more lane carriageway sections F, in particular on a motorway, from a left lane F1 or a right lane F3 to the middle lane F2, another vehicle PE1 to PE3 may decide to change to the same target lane ZS at the same time, even without any recognizable intention. Such a case represents a comparatively critical situation.

In lane change maneuvers, there is therefore a risk of a collision with other vehicles PE1 to PE3 which could change to the middle lane F2 at the same time.

While a human driver of the vehicle EGO can, on the basis of their previous experience, assess the behaviour of surrounding traffic during lane change maneuvers, also taking into account objects, i.e., road users, in the right lane F3, which is the next but one lane with respect to FIG. 1, in order to then assess their tactical driving decision in terms of attractiveness and feasibility, automated vehicle systems are dependent on rule sets that assess a planned tactical behaviour on the basis of measurement data from a surroundings sensor system.

In particular, there is neither a risk quantification, in particular in the form of a safety measure S1, S2, nor a calculation rule for a desired target behaviour for the automated driving system of the vehicle EGO.

In order to assess a lane change maneuver into the middle lane F2, taking into account object information in the next but one lane, i.e., the right lane F3, at a tactical level, it is therefore necessary to define measured variables and parameters that allow the collision risk of these objects to be quantified during lane change maneuvers. Based on this, a desired target behaviour for the automated driving system can then be derived.

The following describes a method for the safety assessment of a lane change maneuver in autonomous driving operation of the vehicle EGO with a surroundings sensor system, wherein surroundings of the vehicle EGO and objects located in these surroundings are detected on the basis of signals captured by the surroundings sensor system.

To carry out the method, it is assumed that lane change maneuvers of the other vehicles PE1 to PE3 cannot be predicted.

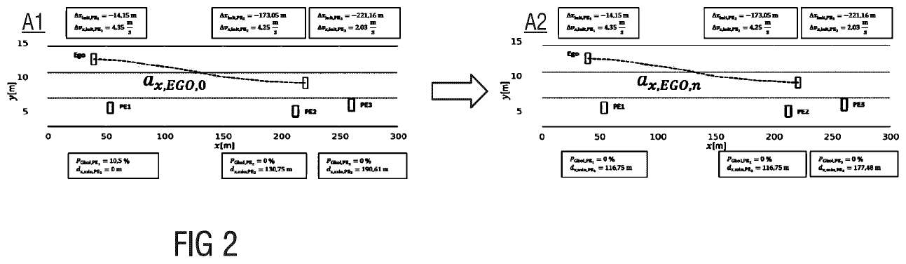

FIG. 2 shows two depictions A1, A2 with a carriageway section F and the same initial situation Δx_{MM,init,PE}_{ᵢ}, Δv_{x,init,PE}_{ᵢ}, wherein the vehicle EGO is driving in the left lane F1 and intends to perform a lane change maneuver into the middle lane F2. Three other vehicles PE1 to PE3 are driving in the right lane F3.

A lane change maneuver of the vehicle EGO into the middle lane F2 is checked with regard to a collision by means of hypothetical lane change maneuvers of the other vehicles PE1 to PE3, wherein the other vehicles PE1 to PE3 can be passenger cars or lorries. This means that each of the other vehicles PE1 to PE3 represents a potential merger for the vehicle EGO. The other vehicles PE1 to PE3 can also be other means of transport, such as motorbikes, wherein acceleration ranges are also determined and the same principle is used to analyse the risk of the vehicle EGO changing lanes.

To check the lane change maneuver using the hypothetical lane change maneuvers of the other vehicles PE1 to PE3, longitudinal accelerations a_{x,PE} which lead to a collision due to an overlap of vehicle surfaces between the vehicle EGO and one of the other vehicles PE1 to PE3 are calculated using linearized transverse profiles, in particular on the basis of a maximum lane change duration and a merging moment. For this purpose, it is defined that a probability of occurrence of the respective longitudinal accelerations a_{x,PE}, which lead to a collision, simultaneously describes the probability of a collision or corresponds to the probability of a collision, since the longitudinal acceleration a_{x,PE} is directly related to an overlap of the vehicle surfaces and thus to a collision.

An assessment of the lane change maneuver occurs at a tactical level depending on a relative longitudinal position Δx_{MM,init,PE}_{ᵢ}, also referred to as the initial distance between vehicle centres, as vehicle measurement 1 and an initial relative longitudinal speed Δv_{x,init,PE}_{ᵢ} as vehicle measurement 2 at the start of the lane change maneuver using two safety measures S1, S2.

The relative longitudinal position Δx_{MM,init,PE}_{ᵢ} is calculated as follows:

Δx_{MM,init,PE}_{ᵢ}=x_{M,EGO,init}−x_{M,PE}_{ᵢ}_{,init} (1)

The initial relative longitudinal velocity Δv_{x,init,PE}_{ᵢ} is calculated as follows:

Δv_{x,init,PE}_{ᵢ}=v_{x,EGO,init}−v_{x,PE}_{ᵢ}_{,init} (2)

In particular, an initial longitudinal distance is negative if the vehicle EGO is driving behind another vehicle PE1 to PE3. The situation is similar with a relative speed Δvₓ₍ₜ_{_{SP}}₎, which is positive if the vehicle EGO has a higher longitudinal speed v_{x,EGO,init} than another vehicle PE1 to PE3.

A safety measure S1 forms a collision probability and a further safety measure S2 represents a minimum distance d_{x,min} between the vehicle EGO and the other vehicles PE1 to PE3 if no collision is imminent.

An assessment of the collision probability as a safety measure S1 is carried out using a collision probability which emerges from a previously determined probability of expected longitudinal accelerations a_{x,PE} of the other vehicles PE1 to PE3, using the initial situation Δx_{MM,init,PE}_{ᵢ}, Δv_{x,init,PE}_{ᵢ}, using geometric vehicle information LEGO of the vehicle EGO, geometric vehicle information l_{PE} of the other vehicles PE1 to PE3, the lane change start times of the other vehicles PE1 to PE3, a duration of the lane change maneuver and a planned longitudinal acceleration a_{x,EGO,n} of the vehicle EGO.

An assessment of the minimum distance d_{x,min} as a further safety measure S2 is carried out using a minimum longitudinal distance between the bumpers closest to one another. The minimum distance d_{x,min} is selected during the entire lane change maneuver after transverse coordinates between the vehicle EGO and at least one other vehicle PE1 to PE3 intersect. The two safety measures S1 and S2 are calculated on the basis of a model.

By changing the longitudinal acceleration a_{x,EGO,n}, represented by the index n, and/or a lane change duration, the vehicle EGO can influence the collision probability and the minimum distance d_{x,min} during the lane change maneuver.

A first depiction A1 shows a scenario with three other vehicles PE1 to PE3 as potential mergers into the middle lane F2 in their respective initial situation Δx_{MM,init,PE}_{ᵢ}, Δv_{x,init,PE}_{ᵢ}.

A total collision probability P_{GKol,PE}_{ᵢ}_{,n}>0 of the vehicle EGO exists for the vehicle EGO with a further first vehicle PE1, wherein in the first depiction A1 a minimum distance d_{x,min} to the respective further vehicle PE1 to PE3 applies at a longitudinal acceleration a_{,x,EGO,0}, which is set to zero at a total collision probability P_{GKol,PE}_{ᵢ}_{,n}>0.

In a second depiction A2 in FIG. 2, the same initial situation Δx_{MM,init,PE}_{ᵢ}, Δv_{x,init,PE}_{ᵢ} is depicted as in the first depiction A1. The vehicle EGO has a modified longitudinal acceleration a_{x,EGO,n}, resulting in new values for the respective collision probability and the respective minimum distance d_{x,min}.

The vehicle EGO is therefore able to reduce a collision risk even before the initiated lane change maneuver or to deliberately postpone the start of the lane change maneuver if a positive or negative acceleration effort of the vehicle EGO is too high and/or until the initial situation for a safe lane change has improved.

To execute the method, a definition for a start time and an end time of the lane change maneuver is required in order to distinguish one present scenario from other scenarios. These times are determined according to the method known from the source:

Vasile, Laurin, Kiran Divakar, and Dieter Schramm. Deep-Learning Basierte Verhaltensprädiktion Rückwärtiger Verkehrsteilnehmer Für Hochautomatisierte Spurwechsel (Deep-Learning Based Behaviour Prediction for Rearward-Facing Road Users for Highly Automated Lane Changes) Transforming Mobility—What Next?—Tagungsband zum 13. Wissenschaftsforum Mobilität: Springer Fachmedien Wiesbaden, 2021.

By means of a defined start and end time of a lane change maneuver, averaged longitudinal accelerations are determined from a real driving data set on the basis of the recorded measurement data depending on a lane change direction, in particular in relation to a faster/slower lane F1 to F3, and a vehicle class, with which lane change maneuvers are carried out. In addition, the probability of an averaged longitudinal acceleration with which the lane change maneuver is carried out is also determined. A probability density function pdf, whose integral describes the probability of a corresponding acceleration range, is created via a frequency distribution depending on the lane change direction and vehicle class. The probability density function pdf is then applied to the other vehicles PE1 to PE3 depending on the lane change direction and their vehicle class.

Based on the measurement data, a lane change duration t_{PE}(Δy_{PE,ZM}) is also determined using the start and end time depending on a distance Δy_{PE,ZM} of a vehicle PE1 to PE3 to a target lane centre ZM, a lane change direction, in particular in relation to a faster/slower lane F1 to F3, and a vehicle class. The lane change duration t_{PE}(Δy_{ZM}) is determined by averaging several lane change maneuvers that have a similar distance Δy_{PE,ZM} to the target lane centre ZM.

Using the longitudinal acceleration determined, a model is developed by means of which the collision probability can be determined, in particular can be calculated, as a safety measure S1 and the minimum distance d_{x,min} between the vehicle EGO and the other vehicles PE1 to PE3 as a further safety measure S2 on the basis of a respective initial situation Δx_{MM,init,PE}_{ᵢ}, Δv_{x,init,PE}_{ᵢ}, and which takes into account the possible influence of the vehicle EGO by changing its longitudinal acceleration a_{x,EGO,n}.

Longitudinal acceleration ranges and their probability are used to calculate the collision probability as a safety measure S1. This involves checking which longitudinal accelerations a_{x,PE} of the respective other vehicle PE1 to PE3 lead to a collision with the vehicle EGO during a lane change maneuver into the middle lane F2.

Lane change maneuvers of the vehicle EGO are assessed on the basis of the initial situation Δx_{MM,init,PE}_{ᵢ}, Δv_{x,init,PE}_{ᵢ} to one or more other vehicles PE1 to PE3 in the right lane F3. This assessment is described via an initial distance Δx_{MM,init,PE}_{ᵢ} between the two vehicle centres and an initial relative longitudinal speed Δv_{x,init,PE}_{ᵢ}. These two parameters are detected on the basis of signals detected by the surroundings sensor system of the automated, in particular autonomous, driving vehicle EGO.

Based on the initial situation Δx_{MM,init,PE}_{ᵢ}, Δv_{x,init,PE}_{ᵢ}, a minimum longitudinal acceleration a_{x,PE,min} and a maximum longitudinal acceleration a_{x,PE,max} of the other vehicles PE1 to PE3 are then determined, for which a collision just occurs during a lane change maneuver with a linearized lateral profile of the vehicle EGO and the other vehicles PE1 to PE3. Values within these longitudinal acceleration limits, including the limit values, also lead to a collision.

A necessary longitudinal acceleration range a_{x,PE,min} to a_{x,PE,max} of the other vehicles PE1 to PE3, which leads to a potential collision, can be influenced by the longitudinal acceleration a_{x,EGO}, wherein different longitudinal accelerations a_{x,EGO,n} are represented by means of the index n.

A time period to be considered is defined by a maximum of the lane change duration (SWD) t_{Ego} of the vehicle EGO and the other vehicles PE1 to PE3 tₘₐₓ=max(t_{PE}(Δy_{ZM}),t_{Ego}) is defined.

This is done in particular because a longer lane change duration provides more time to reduce a higher initial relative longitudinal speed Δv_{x,init,PE}_{ᵢ} and distances with a lower acceleration difference between the vehicle EGO and at least one of the other vehicles PE1 to PE3, wherein this represents a more critical case. Such a case is described below. In addition, the start of the time period to be considered, within which a collision can occur, is defined by a time t_{EM} of a merging process.

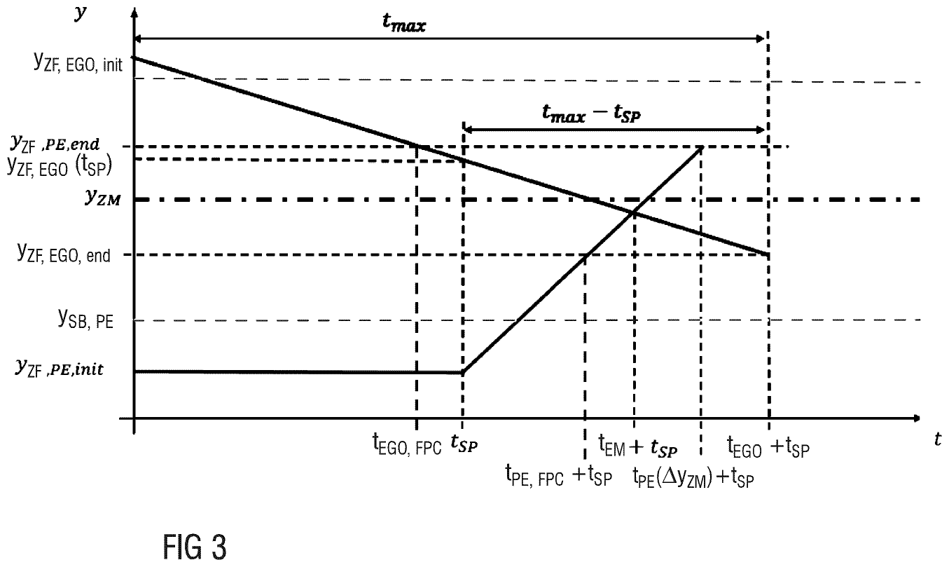

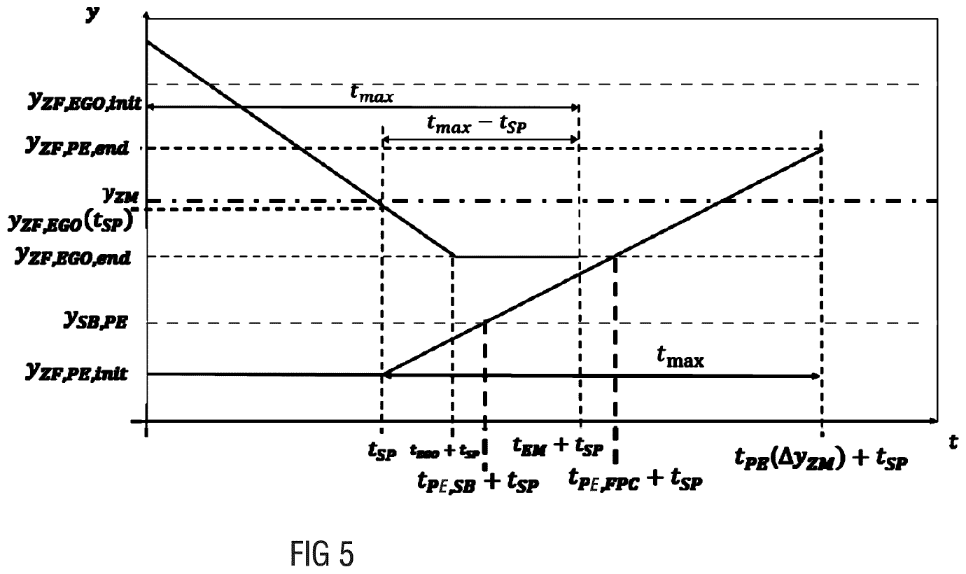

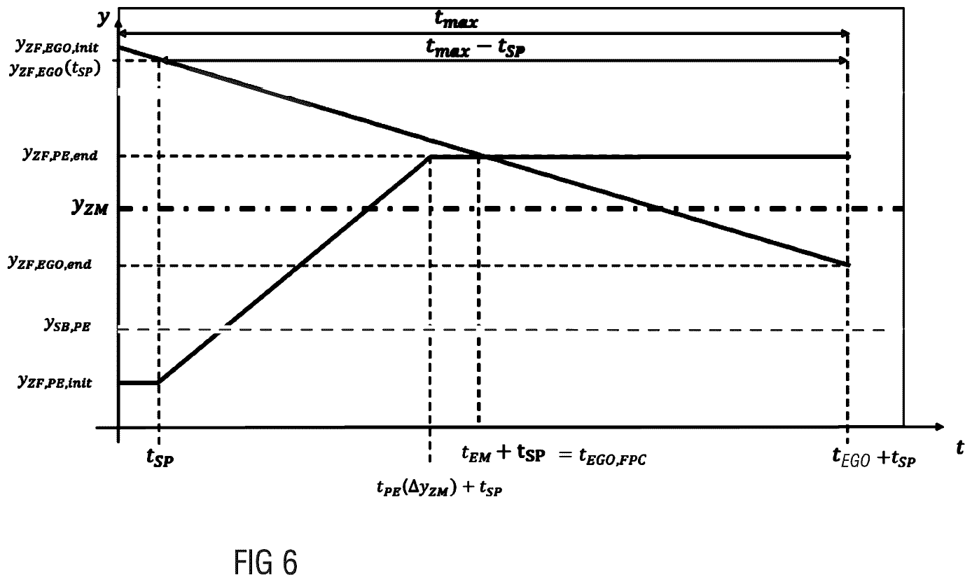

In order to determine the time t_{EM} of the merging process of both vehicles EGO, PE1 to PE3, i.e., the time at which the two vehicle surfaces laterally overlap for the first time, transverse movements of the vehicle EGO and the corresponding additional vehicle PE1 to PE3 are linearized. FIGS. 3 to 6 each illustrate a calculation rule and show four possible cases.

Assuming a constant lateral speed, the initial distance Δy_{PE,ZM} to the centre of the target lane ZM can be used to calculate four possible times t_{EM} for a merging process.

### Case 1

An exemplary embodiment shown in FIG. 3 shows possible intersections of resulting straight lines, which represent the linearized transverse movement of the vehicle sides facing the vehicle (ZF).

If the two vehicle surfaces intersect before one of the two lane change maneuvers is completed, the following applies:

$${t}_{EM} = \frac{\vert {y}_{ZF , Ego} ( {t}_{SP} ) - {y}_{ZF , PE , init} \vert}{\vert {v}_{y , Ego} + {v}_{y , PE} \vert} \qquad ( 3 )$$

### Condition

$$( {τ}_{EGO} = \frac{\vert {y}_{ZF , Ego , End} - {y}_{ZF , Ego} ( {t}_{SP} ) \vert}{\vert {v}_{y , Ego} \vert} \geq {t}_{PE , FPC} = \frac{\vert {y}_{ZF , Ego , End} - {y}_{ZF , PE , init} \vert}{\vert {v}_{y , PE} \vert} ) ∧ \qquad ( 4 )$$

$$( {t}_{PE} ( Δ {y}_{ZM} ) = \frac{\vert {y}_{ZF , PE , End} - {y}_{ZF , PE , init} \vert}{\vert {v}_{y , PE} \vert} + {t}_{SP} > {t}_{EGO , FPC} = \frac{{y}_{ZF , Ego , init} - {y}_{ZF , PE , End}}{\vert {v}_{y , EGO} \vert} )$$

t_{SP} describes a shift in the start of the lane change maneuver of the corresponding additional vehicle PE1 to PE3. By assuming that there are lane change maneuvers that cannot be detected in context, the corresponding additional vehicle PE1 to PE3 can also decide to change lane F1 to F3 at any possible point in time of the lane change maneuver of the vehicle EGO.

By shifting t_{SP} the start of the lane change maneuver of the corresponding additional vehicle PE1 to PE3 to a later point in time, the time period to be considered is shortened.

An initial position and relative speed are calculated as follows:

$$Δ {x}_{MM} ( {t}_{SP} ) = Δ {x}_{MM , init , {PE}_{i}} + Δ {v}_{x , init , {PE}_{i}} {t}_{SP} + \frac{1}{2} ( {a}_{x , Ego , n} - {a}_{x , {PE}_{i} , init} ) {t}_{SP}^{2} \qquad ( 5 )$$

$$Δ {v}_{x} ( {t}_{SP} ) = Δ {v}_{x , init , {PE}_{i}} + ( {a}_{, Ego , n} - {a}_{x , {PE}_{i} , init} ) {t}_{SP} \qquad ( 6 )$$

It is assumed that the initial longitudinal acceleration a_{x,PE}_{ᵢ}_{,init} of further vehicles PE1 to PE3 cannot be measured exactly or only inaccurately and is assumed to be zero for the method described here.

$${y}_{ZF , EGO )} ( {t}_{SP} ) = {y}_{ZF , EGO , init} + {v}_{y , EGO} {t}_{SP} \qquad ( 7 )$$

$${t}_{SP} ∈ [ 0 , {t}_{m ax} - \frac{\vert {y}_{SB , PE} - {y}_{ZF , PE , init} \vert}{\vert {v}_{y , PE} \vert} ] \qquad ( 8 )$$

A first possible contact FPC between the vehicle EGO and the corresponding other vehicle PE1 to PE3 is also depicted with labels in FIG. 3.

### Case 2

If the corresponding additional vehicle PE1 to PE3 reaches a lateral end position of the vehicle EGO after the vehicle EGO has completed its lateral movement, but before the end of the period under consideration (tₘₐₓ−t_{SP}), the following applies:

$${t}_{EM} = \frac{\vert {y}_{ZF , Ego , End} - {y}_{ZF , PE , init} \vert}{\vert {v}_{y , PE} \vert} \qquad ( 9 )$$

### Condition

$$( {t}_{P E} ( Δ {y}_{Z M} ) > {t}_{E g o} ) ∧ \qquad ( 10 )$$

$$( {t}_{max} - {t}_{S P} \geq {t}_{P E , F P C} = \frac{\vert {y}_{ZF , Ego , End} - {y}_{ZF , PE , init} \vert}{\vert {v}_{y , PE} \vert} \geq {t}_{E G O} = \frac{\vert {y}_{ZF , Ego , End} - {y}_{ZF , Ego} ( {t}_{SP} ) \vert}{\vert {v}_{y , Ego} \vert} )$$

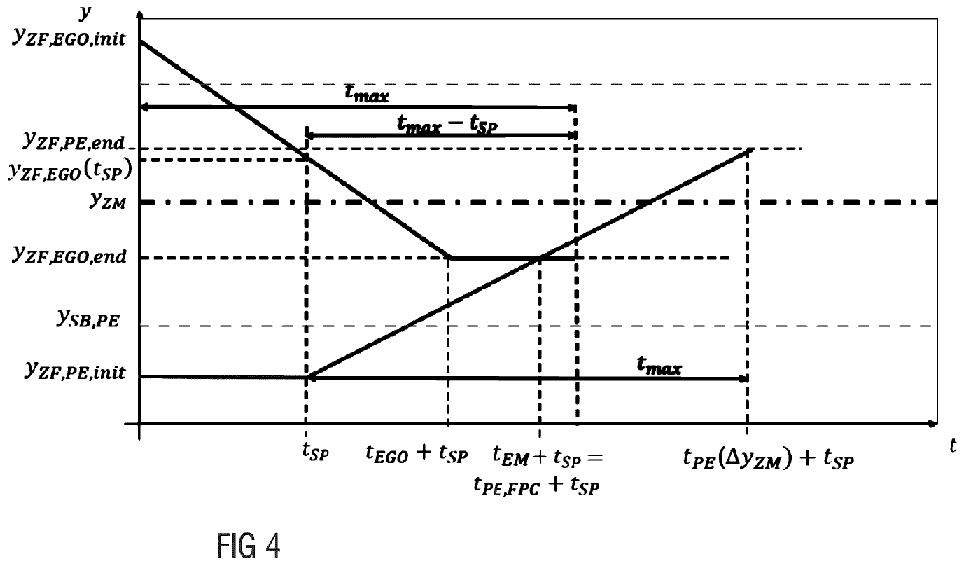

as is shown in the exemplary embodiment in FIG. 4.

### Case 3

If the corresponding additional vehicle PE1 to PE3 only reaches the lateral end position after an end of the period of time under consideration (tₘₐₓ−t_{SP}), but still reaches the lane boundary (y_{SB,PE}) of the target lane ZS within the period of time under consideration (tₘₐₓ−t_{SP}), the following applies:

t_{EM}=tₘₐₓ−t_{SP} (11)

### Condition

$${t}_{PE , FPC} = \frac{\vert {y}_{ZF , Ego , End} - {y}_{ZF , PE , init} \vert}{\vert {v}_{y , PE} \vert} > {t}_{max} - {t}_{S P} \geq {t}_{PE , SB} = \frac{\vert {y}_{SB , PE} - {y}_{ZF , PE , init} \vert}{\vert {v}_{y , PE} \vert} .$$

Although there is no actual overlap between vehicle surfaces, a period of both vehicles EGO, PE1 to PE3 being next to each other in the same lane F2 is considered critical and is therefore assessed as an overlap.

### Case 4

If the corresponding additional vehicle PE1 to PE3 reaches its lateral end position before the vehicle EGO reaches a lateral end position of the corresponding additional vehicle PE1 to PE3, the following applies:

$${t}_{E M} = \frac{\vert {y}_{ZF , Ego} ( {t}_{SP} ) - {y}_{ZF , PE , End} \vert}{\vert {v}_{y , Ego} \vert} \qquad ( 12 )$$

### Condition

$${t}_{EGO , FPC} - {t}_{S P} = \frac{\vert {y}_{ZF , Ego , init} - {y}_{ZF , PE , End} \vert}{\vert {v}_{y , Ego} \vert} - {t}_{S P} \geq {t}_{P E} ( Δ {y}_{Z M} ) = \frac{\vert {y}_{ZF , PE , End} - {y}_{ZF , PE , init} \vert}{\vert {v}_{y , PE} \vert} \qquad ( 13 )$$

Equation (13) concludes case 4.

A minimum longitudinal acceleration a_{x,PE}_{ᵢ}_{,min} and a maximum longitudinal acceleration a_{x,PE}_{ᵢ}_{,max} of the corresponding additional vehicle PE1 to PE3 are determined using the following calculation rule. Values within these limits, including limit values, lead to a collision for a given initial situation ΔxM_{M,init,PE}_{ᵢ}, Δv_{x,init,PE}_{ᵢ}.

### Acceleration Difference Borderline Cases:

$$Δ {a}_{Gf , {t}_{max}} = - \frac{Δ {v}_{x} ( {t}_{S P} )}{{t}_{max} - {t}_{SP}} ; Δ {a}_{b o r d e rline case , {t}_{E M}} = - \frac{Δ {v}_{x} ( {t}_{S P} )}{{t}_{E M}} \qquad ( 14 )$$

### Start Position Borderline Cases (Gf):

$$Δ {x}_{MM , Gf , {t}_{max}} = \{ \begin{matrix}\frac{1}{2} Δ {{a}_{Gf , {t}_{max}} ( {t}_{max} - {t}_{SP} )}^{2} - L & for Δ {v}_{x} ( {t}_{SP} ) \geq 0 \\ \frac{1}{2} Δ {{a}_{Gf , {t}_{max}} ( {t}_{max} - {t}_{SP} )}^{2} + L & for Δ {v}_{x} ( {t}_{SP} ) < 0\end{matrix} ; \qquad ( 15 )$$

$$Δ {x}_{MM , Gf , {t}_{E M}} = \{ \begin{matrix}\frac{1}{2} Δ {a}_{Gf , {t}_{max}} {t}_{EM}^{2} - L & for Δ {v}_{x} ( {t}_{SP} ) \geq 0 \\ \frac{1}{2} Δ {a}_{Gf , {t}_{max}} {t}_{EM}^{2} + L & for Δ {v}_{x} ( {t}_{SP} ) < 0\end{matrix} \qquad ( 16 )$$

$$Δ {x}_{MM , {a}_{min , equal}} = - Δ {v}_{x} ( {t}_{S P} ) \frac{{t}_{EM}}{1 + \frac{{t}_{EM}}{{t}_{max} - {t}_{SP}}} + L \qquad ( 17 )$$

$$for Δ {v}_{x} ( {t}_{S P} ) \geq 0 ;$$

$$Δ {x}_{MM , {a}_{max , equal}} = - Δ {v}_{x} ( {t}_{S P} ) \frac{{t}_{EM}}{1 + \frac{{t}_{EM}}{{t}_{max} - {t}_{SP}}} - L \qquad ( 18 )$$

$$for Δ {v}_{x} ( {t}_{S P} ) < 0$$

$$with : L = \frac{{l}_{E G O} + {l}_{P {E}_{i}}}{2} ; {l}_{E G O} = vehicle lengths EGO ,$$

$${l}_{P {E}_{i}} = vehicle lengths PE 1 to PE 3$$

$$Δ {x}_{MM , {t}_{max}} = Δ {x}_{M M} ( {t}_{S P} ) + Δ {v}_{x} ( {t}_{S P} ) ( {t}_{max} - {t}_{S P} ) + \frac{1}{2} {{a}_{x , Ego , n} ( {t}_{max} - {t}_{S P} )}^{2} ; \qquad ( 19 )$$

$$Δ {x}_{MM , {t}_{E M}} = Δ {x}_{M M} ( {t}_{S P} ) + Δ {v}_{x} ( {t}_{S P} ) {t}_{E M} + \frac{1}{2} {a}_{x , Ego , n} {t}_{E M}^{2} \qquad ( 20 )$$

$${a}_{x , {PE}_{i} , max} = \{ \begin{matrix}\frac{2 ( Δ {x}_{MM , {t}_{max}} + L )}{{( {t}_{max} - {t}_{SP} )}^{2}} & \begin{matrix}for ( Δ {x}_{MM} ( {t}_{SP} ) < Δ {x}_{MM , Gf , {t}_{max}} ∧ \\ \begin{matrix}Δ {v}_{x} ( {t}_{SP} ) \geq 0 ) ∨ ( Δ {x}_{MM} ( {t}_{SP} ) \leq \\ Δ {x}_{MM , {a}_{max , equal}} ∧ Δ {v}_{x} ( {t}_{SP} ) < 0 )\end{matrix}\end{matrix} 21 a ) \\ {a}_{x , Ego , n} - \frac{1}{2} \frac{Δ {v}_{x}^{2} ( {t}_{SP} )}{Δ {x}_{MM} ( {t}_{sp} ) + L} & \begin{matrix}for Δ {x}_{MM , Gf , {t}_{max}} \leq Δ {x}_{MM} ( {t}_{SP} ) \leq \\ Δ {x}_{MM , Gf , {t}_{EM}} ∧ Δ {v}_{x} ( {t}_{SP} ) \geq 0\end{matrix} 21 b ) \\ \frac{2 ( Δ {x}_{MM , {t}_{EM}} + L )}{{t}_{EM}^{2}} & \begin{matrix}for ( Δ {x}_{MM , Gf , {t}_{EM}} < Δ {x}_{MM} ( {t}_{SP} ) ∧ \\ \begin{matrix}Δ {v}_{x} ( {t}_{SP} ) \geq 0 ) ∨ ( Δ {x}_{MM , {a}_{max , equal}} < \\ Δ {x}_{MM} ( {t}_{SP} ) ∧ Δ {v}_{x} ( {t}_{SP} ) < 0 )\end{matrix}\end{matrix} 21 c )\end{matrix}$$

$${a}_{x , {PE}_{i} , max} = \{ \begin{matrix}\frac{2 ( Δ {x}_{MM , {t}_{max}} - L )}{{( {t}_{max} - {t}_{SP} )}^{2}} & \begin{matrix}for ( Δ {x}_{MM , Gf , {t}_{max}} < Δ {x}_{MM} ( {t}_{SP} ) ∧ \\ \begin{matrix}Δ {v}_{x} ( {t}_{SP} ) < 0 ) ∨ ( Δ {x}_{MM , {a}_{min , equal}} \leq \\ Δ {x}_{MM} ( {t}_{SP} ) ∧ Δ {v}_{x} ( {t}_{SP} ) \geq 0 )\end{matrix}\end{matrix} 22 d ) \\ {a}_{x , Ego , n} - \frac{1}{2} \frac{Δ {v}_{x}^{2} ( {t}_{SP} )}{Δ {x}_{MM} ( {t}_{sp} ) - L} & \begin{matrix}for Δ {x}_{MM , Gf , {t}_{EM}} \leq Δ {x}_{MM} ( {t}_{SP} ) \leq \\ Δ {x}_{MM , Gf , {t}_{max}} ∧ Δ {v}_{x} ( {t}_{SP} ) < 0\end{matrix} 22 e ) \\ \frac{2 ( Δ {x}_{MM , {t}_{EM}} + L )}{{t}_{EM}^{2}} & \begin{matrix}for ( Δ {x}_{MM} ( {t}_{SP} ) < Δ {x}_{MM , Gf , {t}_{EM}} ∧ \\ \begin{matrix}Δ {v}_{x} ( {t}_{SP} ) < 0 ) ∨ ( Δ {x}_{MM} ( {t}_{SP} ) < \\ Δ {x}_{MM , {a}_{min , equal}} ∧ Δ {v}_{x} ( {t}_{SP} ) \geq 0 )\end{matrix}\end{matrix} 21 f )\end{matrix}$$

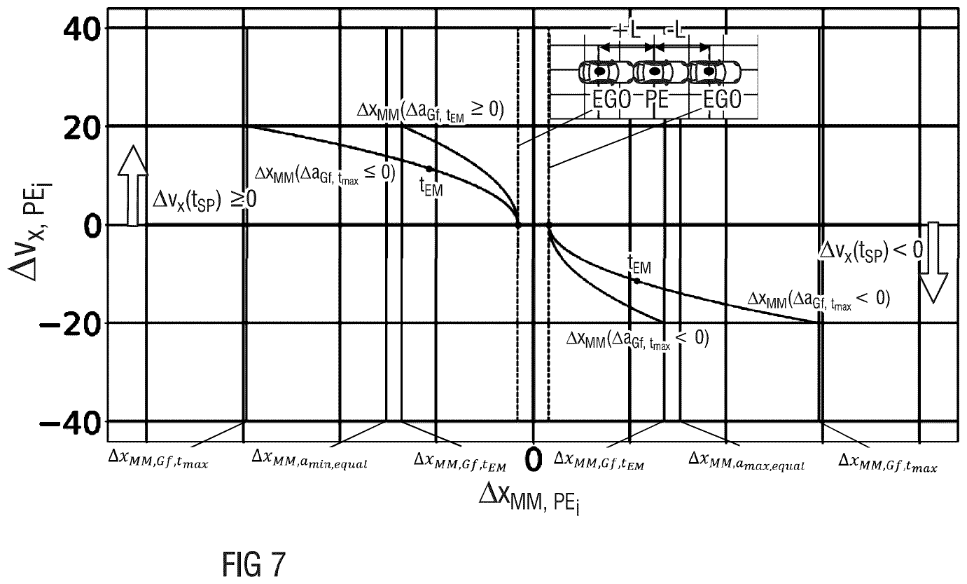

FIG. 7 shows explanations of the calculation rule.

An acceleration borderline case is formed by an acceleration difference Δa_{Gf,t}_{ₘₐₓ}_{/t}_{_{EM}}′ with which the relative speed Δvₓ(t_{SP}) is completely reduced at the point in time t_{SP} at the end of the lane change or at the point in time t_{EM} of the merging process.

Depending on the sign of the relative speed Δvₓ(t_{SP}) at the point in time t_{SP}, the initial borderline case distance Δx_{MM,Gf,t}_{ₘₐₓ}_{/t}_{_{EM}} of the vehicle centres can be calculated, which would be necessary so that at a given relative speed Δvₓ(t_{SP}), a final point of approach before the vehicles EGO, PE1 to PE3 would move away from each other again is a contact of the bumpers.

If the distance Δx_{MM}(t_{SP}) of the vehicle centres at the point in time t_{SP} is between the limits determined in equations (15) and (16), a differential acceleration is sought for which the bumpers of the vehicles EGO, PE1 to PE3 touch each other (Δx_{SS,t}=0) before the vehicles EGO, PE1 to PE3 move away from each other again. This is the case if:

$$Δ {x}_{S S , t} = Δ {x}_{MM , ini𝔱} ( {t}_{S P} ) \pm L + Δ {v}_{x} ( {t}_{S P} ) t + \frac{1}{2} ( {a}_{x , Ego , n} - {a}_{x , PE} ) {t}^{2} ; \qquad ( 23 )$$

$$t ∈ {t}_{E M} , ( {t}_{max} - {t}_{S P} )$$

solved according to t results in only one solution. This is the case if the square root of the solution for quadratic equations with the form ax²+bx+c=0 results in zero. The calculation for a time of contact of the bumpers Δx_{SS,t} lies between the point in time t_{EM} of the merging process and an end of the lane change maneuver and is calculated for each shift t_{SP} of the start time.

The number of possible cases in equations (21) and (22) changes depending on the sign of the relative speed Δvₓ(t_{SP}) at the point in time t_{SP}. If the relative speed is positive Δvₓ(t_{SP}), the maximum longitudinal acceleration a_{x,PE}_{ᵢ}_{,max} is determined by equation (21a), (21b) or (21c), while the minimum longitudinal acceleration a_{x,PE}_{ᵢ}_{,min} is only determined by equation (22d) or (22f). With a negative relative speed Δvₓ(t_{SP}), the reverse is true, wherein the maximum longitudinal acceleration a_{x,PE}_{ᵢ}_{,max} is then determined by equation (21a) or (21c). Equation (17) for the borderline case position for the minimum longitudinal acceleration a_{x,PE}_{ᵢ}_{,min} at positive relative speed Δvₓ(t_{SP}) is obtained by equating equations (22d) and (22f), or equation (18) for the borderline case position for the maximum longitudinal acceleration a_{x,PE}_{ᵢ}_{,max} at negative relative speed Δvₓ(t_{SP}) by equating equations (21a) and (21c).

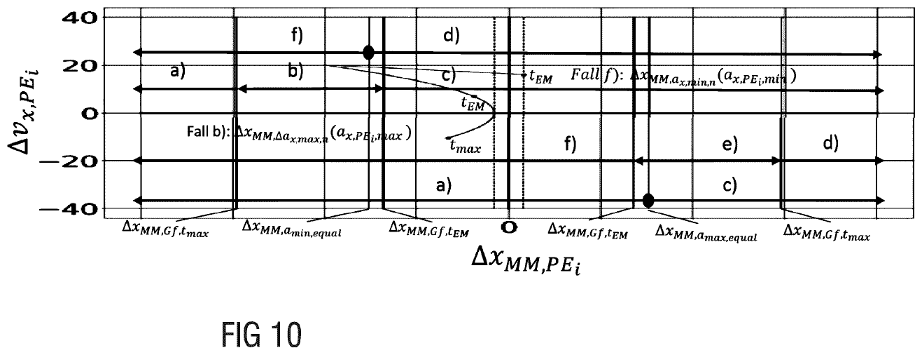

FIG. 10 illustrates the borderline case positions from the equations (15) to (18) and individual ranges from the equations (21a-c) and (22d-f).

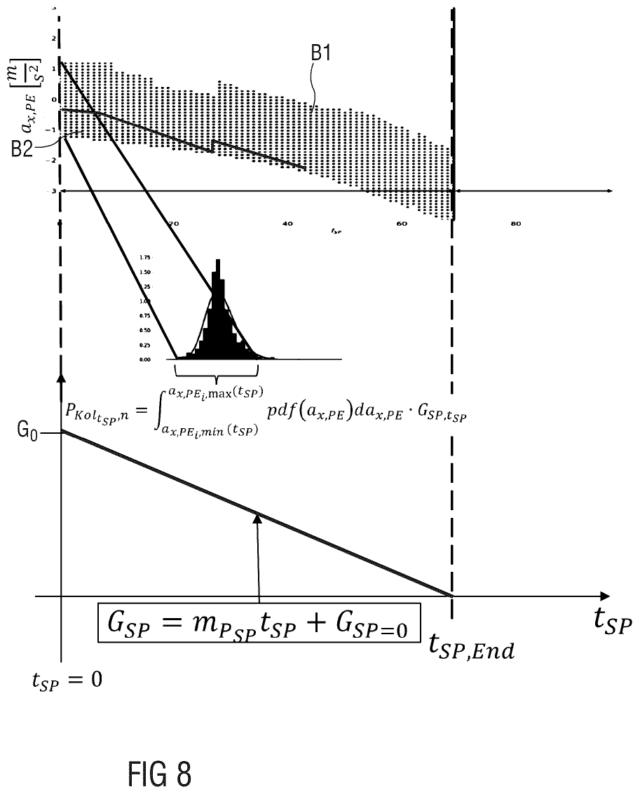

Determined longitudinal acceleration values a_{x,PE,min} and a_{x,PE,max} from equations (21a) to (21c) and (22d) to (22f) are then used as integral limits, as shown in FIG. 8, when calculating the collision probability as a safety measure S1. For this purpose, the probability density function pdf determined at an earlier point in time is integrated. The collision probability is weighted depending on the shift t_{SP}, wherein the weighting is defined by a straight line G_{SP,t}_{_{SP}} shown in FIG. 8. In particular, FIG. 8 shows a derivation of the collision probability as a safety measure S1.

The reason for the weighting limit is: the later the lane change maneuver begins for the corresponding additional vehicle PE1 to PE3, the less time is available to complete the lane change maneuver, which reduces the risk of a collision. Furthermore, it can be assumed that as the lane change maneuver of the vehicle EGO progresses, the probability that a lane change will be started by other vehicles PE1 to PE3 also decreases, as the probability increases with which the movement of the vehicle EGO is perceived by other vehicles PE1 to PE3. The weighted individual collision probabilities are then totalled to form an overall collision probability P_{GKol,PE}_{ᵢ}_{,n}. The overall collision probability P_{GKol,PE}_{ᵢ}_{,n} can also be calculated without a weighting line and used as a safety measure S1.

$${P}_{G K o l , P {E}_{i} , n} = {\sum }_{{t}_{S P} = 0}^{{t}_{SP , End}} {\int }_{{a}_{x , {PE}_{i} , min ( {t}_{SP} )}}^{{a}_{x , {PE}_{i} , max} ( {t}_{SP )}} pdf ( {a}_{x , PE} ) {da}_{x , PE} \cdot {G}_{SP , {t}_{SP}} \qquad ( 24 )$$

In an upper area of FIG. 8, two areas B1, B2 are shown with different shading. A first area B1 represents possible transverse collisions due to overlapping vehicle surfaces between the vehicle EGO and a corresponding additional vehicle PE1 to PE3.

A lower area B2 represents a possible occurrence of longitudinal collisions between the vehicle EGO and the corresponding additional vehicle PE1 to PE3.

By means of the straight line G_{SP,t}_{_{SP}}, an area

$${A}_{G} = 1 = \frac{1}{2} {G}_{0} {t}_{SP , End}$$

is formed below it. In addition, a point of intersection with the abscissa is defined by means of a last relevant start time t_{SP,End} for the lane change of the corresponding additional vehicle PE1 to PE3. This last relevant start time t_{SP,End} represents a time at which the corresponding additional vehicle PE1 to PE3 begins its lane change maneuver and at which a time is sufficient to touch the lane boundary SB of the target lane ZS with the vehicle surface facing the vehicle EGO.

A point of intersection G₀ with the ordinate axis results from a requirement for the area

$${A}_{G} = 1 = \frac{1}{2} {G}_{0} {t}_{SP , End}$$

below the straight lines

$${G}_{SP , {t}_{S P}} to {G}_{0} = \frac{2}{{t}_{SP , End}} .$$

A gradient m_{G}_{_{SP}} of the straight line G_{SP,t}_{_{SP}} is determined as follows:

$${m}_{{G}_{S P}} = - \frac{{G}_{0}}{{t}_{SP , End}} . \qquad ( 25 )$$

The overall collision probability of all PEs is then summed up (AGKol=accumulated GKol, n_{PE}=number of potential mergers).

$${P}_{A G K o l , P E , n} = {\sum }_{i = 1}^{{n}_{P E}} {P}_{G K o l , P {E}_{i} , n} \qquad ( 26 )$$

The overall collision probability P_{AGKol,PE,n} can be integrated into any cost function of a trajectory planning in order to calculate the optimum longitudinal acceleration a_{x,EGO} under various requirements and/or restrictions with regard to motorization, static friction coefficient, comfort requirements, legal requirements, etc. If the calculated acceleration effort of the vehicle EGO, which would be necessary to rule out a potential collision, proves to be too detrimental to other requirements, it is also possible to perform the lane change maneuver at a later point in time when the initial situation for performing a safe lane change maneuver has changed.

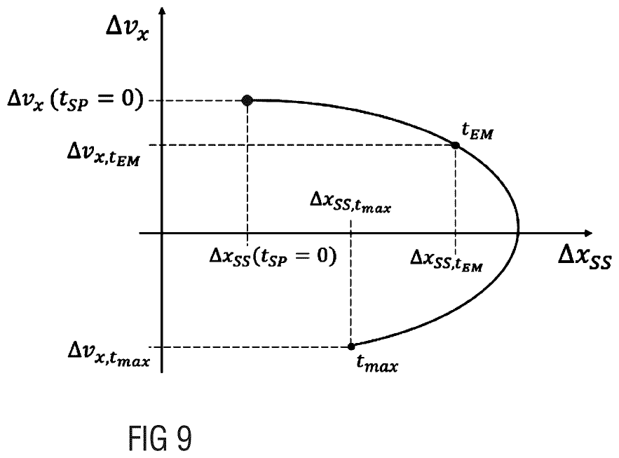

FIG. 9 shows a depiction of a relative longitudinal distance curve of the vehicle bumpers for calculating a minimum distance d_{x,min} between the vehicle EGO and the corresponding other vehicle PE1 to PE3 if no collision occurs between them.

If no collision occurs, the minimum distance d_{x,min}, also known as the minimum longitudinal distance, is used as a further safety measure S2. The minimum distance d_{x,min} is minimal either at the moment of merging t_{EM} or at the moment of maximum lane change duration tₘₐₓ.

In particular, FIG. 9 shows the relationship between the minimum distance d_{x,min} and the relative longitudinal speed Δvₓ(t_{SP}=0) over the lane change maneuver.

The shift t_{SP} of the start time for initiating the lane change maneuver of the corresponding additional vehicle PE1 to PE3 is set to zero, as most of the time is available to reduce a relative longitudinal distance when both lane change maneuvers are started simultaneously.

The distance between the two vehicle bumpers facing each other at the merging moment and at the time of the maximum lane change duration depends on the most critical acceleration of the corresponding additional vehicle PE1 to PE3, depending on the initial situation Δx_{MM,init,PE}_{ᵢ}, Δv_{x,init,PE}_{ᵢ}.

$$Δ {a}_{x , data , max , n} = {a}_{x , Ego , n} - {a}_{x , PE , data , max} ; \qquad ( 27 )$$

$$Δ {a}_{x , data , min , n} = {a}_{x , Ego , n} - {a}_{x , PE , data , min}$$

$$Δ {x}_{SS , {t}_{E M} , Δ {a}_{x , max}} = Δ {x}_{MM , init , {PE}_{i}} - L + Δ {v}_{x , init , {PE}_{i}} {t}_{E M} + \frac{Δ {a}_{x , data , max , n}}{2} {t}_{E M}^{2} \qquad ( 28 )$$

$$Δ {x}_{SS , {t}_{max} , Δ {a}_{x , max}} = Δ {x}_{MM , init , {PE}_{i}} - L + Δ {v}_{x , init , {PE}_{i}} {t}_{max} + \frac{Δ {a}_{x , data , max , n}}{2} {t}_{max}^{2} \qquad ( 29 )$$

$$Δ {x}_{SS , {t}_{E M} , Δ {a}_{x , min}} = Δ {x}_{MM , init , {PE}_{i}} + L + Δ {v}_{x , init , {PE}_{i}} {t}_{E M} + \frac{Δ {a}_{x , data , min , n}}{2} {t}_{E M}^{2} \qquad ( 30 )$$

$$Δ {x}_{SS , {t}_{max} Δ {a}_{x , min}} = Δ {x}_{MM , init , {PE}_{i}} + L + Δ {v}_{x , init , {PE}_{i}} {t}_{max} + \frac{Δ {a}_{x , data , min , n}}{2} {t}_{max}^{2} \qquad ( 31 )$$

A minimum of the minimum distance d_{x,min} then results depending on the case differentiation:

$${d}_{x , min , n} = \{ \begin{matrix}\begin{matrix}min ( \vert Δ {x}_{SS , {t}_{EM} , Δ {a}_{x , min}} \vert , \vert Δ {x}_{SS , {t}_{max} , Δ {a}_{x , min}} \vert ) , \\ for {a}_{x , {PE}_{i} , max} < {a}_{x , PE , data , min}\end{matrix} \\ \begin{matrix}0 , for {a}_{x , PE , data , min} \leq {a}_{x , PE , , min} \leq {a}_{x , PE , data , max} ∨ \\ {a}_{x , PE , data , min} \leq {a}_{x , {PE}_{i} , max} \leq {a}_{x , PE , data , max}\end{matrix} \\ \begin{matrix}min ( \vert Δ {x}_{SS , {t}_{EM} , Δ {a}_{x , max}} \vert , \vert Δ {x}_{SS , {t}_{max} , Δ {a}_{x , max}} \vert ) , \\ for {a}_{x , {PE}_{i} , min} > {a}_{x , PE , data , max}\end{matrix}\end{matrix} \qquad ( 32 )$$

By means of the method, a safety assessment for an automatically driving, in particular autonomously driving, vehicle EGO is enabled.

By changing the longitudinal acceleration a_{x,EGO,n} of the vehicle EGO, the longitudinal accelerations a_{x,PE} of the other vehicles PE1 to PE3 as potential mergers, which would be necessary for a collision, can be shifted so that they are outside a critical range, which was determined using the real driving data. The vehicle EGO is thus able to reduce the risk of a collision before a lane change maneuver to the middle lane F2 or to deliberately postpone the start of the lane change maneuver, which can increase the safety for the vehicle EGO and the other vehicles PE1 to PE3.

1.-4. (canceled)

5. A method for safety assessment of a lane change maneuver in an automatic driving operation of a vehicle (EGO) having a surroundings sensor system, wherein surroundings of the vehicle (EGO) and objects found in the surroundings are detected by signals captured by the surroundings sensor system, comprising the steps of:
before initiating a lane change maneuver of the vehicle (EGO) from a left lane (F1) to a middle lane (F2) or from a right lane (F3) to the middle lane (F2) of a multi-lane carriageway section (F), determining a collision risk by hypothetical lane change maneuvers of other vehicles (PE1 to PE3) in the right lane (F3) or the left lane (F1);
determining longitudinal accelerations (a_{x,PE}) of the other vehicles (PE1 to PE3) on a basis of a maximum lane change duration and a merging moment (t_{EM}), which lead to a collision due to an overlap of vehicle surfaces of the vehicle (EGO) and the other vehicles (PE1 to PE3); and
assessing an execution of the lane change maneuver depending on a relative longitudinal position (Δx_{MM,init,PE}_{ᵢ}) of the vehicle (EGO) relative to the other vehicles (PE1 to PE3) and initial relative longitudinal speeds (Δv_{x,init,PE}_{ᵢ}) of the vehicle (EGO) to the other vehicles (PE1 to PE3) at a start of a lane change maneuver using a collision probability as a safety measure (S1) and a minimum distance (d_{x,min}) when a collision does not occur as a further safety measure (S2).

6. The method according to claim 5, wherein both the safety measure (S1) and the further safety measure (S2) are determined on a basis of a model and wherein the collision probability and the minimum distance (d_{x,min}) during the lane change maneuver are influenced by changing a longitudinal acceleration (a_{x,EGO,n}) and/or an initial situation of the vehicle (EGO) (Δx_{MM,init,PE}_{ᵢ},Δv_{x,init,PE}_{ᵢ}) relative to one of the other vehicles (PE1 to PE3) driving next to the vehicle (EGO).

7. The method according to claim 5, wherein an assessment of the collision probability as a safety measure (S1) is performed using a previously determined probability of expected longitudinal accelerations (a_{x,PE}) of the other vehicles (PE1 to PE3), using the initial situation (ΔxM_{M,init,PE}_{ᵢ},Δv_{x,init,PE}_{ᵢ}), using geometric vehicle information (LEGO) of the vehicle (EGO) and geometric vehicle information (l_{PE}_{ᵢ}) of the other vehicles (PE1 to PE3), using start times of the hypothetical lane change maneuvers of the other vehicles (PE1 to PE3), a duration of the lane change maneuver, and a planned longitudinal acceleration (a_{x,EGO,n}) of the vehicle (EGO).

8. The method according to claim 5, wherein an assessment of the minimum distance (d_{x,min}) as a further safety measure (S2) is performed on a basis of a minimum longitudinal distance of a bumper of the vehicle (EGO) to a bumper of one of the other vehicles (PE1 to PE3) driving next to the vehicle (EGO), wherein the minimum distance (d_{x,min}) is selected during the lane change maneuver after it is determined that transverse coordinates of the vehicle (EGO) and at least one of the other vehicles (PE1 to PE3) intersect.
